(19) United States
(12) Patent Application Publication
(10) Pub. No.: US 2003/0023480 A1
(43) Pub. Date: Jan. 30, 2003

(54) Advertising system on the internet

(75) Inventor: Sadayuki Sakuta, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/910,785

(22) Filed: Jul. 24, 2001

(30) Foreign Application Priority Data
Jul. 24, 2001 (JP) 2000-222413

(51) Int. Cl. G06F 17/60

(52) U.S. Cl. 705/14

(57) ABSTRACT

A user terminal is allowed to access an advertiser's web server only when the access is obtained by linkage through an advertising web server. Thus, the advertiser's web server allows the access requested by the user terminal only if the access is transferred through the advertising web server. The fee for the advertisement depends on the number of accesses made through the advertising web server.

### BACKGROUND OF THE INVENTION

(a) Field of the Invention

The present invention relates to an advertising system on the Internet and, more particularly to, an advertising system on the Internet which allows a user to access the web server of an advertiser (advertiser's web server) at any time through a web server of an advertising agent on which the advertisement for the advertiser's web server is placed.

(b) Description of the Related Art

When it is desired that an advertisement for advertiser's web server be delivered through the Internet, the advertisement is generally offered by a plurality of advertising web servers (or web servers of the advertising agents which have advertising medium on their own web servers), and the users are induced to click the advertisement article on the screen of one of the advertising web servers. After reaching the advertiser's web server, the user often registers the address (URL) of the advertiser's web server on the user terminal so that the user can directly access the advertiser's web server for the next time. In many cases, this means that the user will access the desired advertiser's web server directly, after initially accessing the advertising web server to find the advertiser's web server, without passing through the advertising web server where the advertisement was placed.

The advertising agent or owner of the advertising web server receives a certain advertising fee from each of a plurality of advertisers in return for carrying out their advertisements on the advertising web server, which is designed to attract attentions from many users. In order for an Internet advertising business of the advertising agent to be successful, it is important to carry a larger number of advertisements on the advertising web server as well as to induce as many users as possible to access the advertising medium of the advertising web server. However, those users who have little interest in the advertising web server often learn to directly access the advertiser's web server from the second time, as mentioned above. The result is that the above mentioned goal of the owner of the advertising web server is not achieved.

### SUMMARY OF THE INVENTION

In view of the above problem, it is an object of the present invention to provide an advertising system on the Internet which can induce the users to access the advertiser's web server at any time through the advertising web server.

The present invention provides an internet advertising system including an advertiser's web server having service or good information, an advertising web server having advertising information of said advertiser's web server, a plurality of user terminals, and a network for connecting said advertiser's web server, said advertising web server and said user terminals together for communication, said advertiser's web server allows an access request from each of said user terminals if said access request passes through said advertising web server.

In accordance with the advertising system of the present invention, an attempt to directly access the advertiser's web server from the user terminal is rejected by the advertiser's web server. In a preferred embodiment of the present invention, upon receiving a direct access request from the user terminal, the advertiser's web server can render the user terminal to access the advertiser's web server through the advertising web server. In either case, the user terminal cannot access the advertiser's web server unless the access request is delivered through the advertising web server, thereby increasing the number of users accessing the advertising web server.

The advertising system according to the present invention allows the number of users accessing the advertising web server to increase, thereby facilitating the success of the advertising business of the advertising agent which provides the advertising medium.

The advertising system of the present invention renders a user to access a desired web server through an advertising medium web server. This makes the user, who accesses the advertiser's server, frequently access the advertising web server. Thus, the advertising business of the advertising agent as well as reducing the advertising costs can be facilitated. Alternatively, depending on the extent how popular the advertiser's web site is, there is a possibility that the advertiser can make an advertising income from the advertising agent.

In a preferred embodiment of the advertising system of the present invention, the advertiser's web server permits only those access requests that have a predetermined ID code. In this case, permission to access of the advertiser's web server is offered by having the permitted ID code transferred from the advertising web server to the user.

The above and other objects, features and advantages of the present invention will be more apparent from the following description, referring to the accompanying drawings.

### BRIEF DESCRIPTION OF THE DRAWINGS

FIG. 1 is a block diagram of an internet advertising system according to an embodiment of the invention.

FIG. 2 is an example of an image displayed on a screen of a user terminal.

FIG. 3 is a flowchart showing the process steps in the internet advertising system according to a first embodiment of the invention.

FIG. 4 is a flowchart showing the process steps in the advertising system of FIG. 1.

FIG. 5 is an example of an image displayed on the screen of the user terminal.

FIG. 6 is a part of a flowchart showing the process steps in a second embodiment of the present invention.

### DESCRIPTION OF THE PREFERRED EMBODIMENTS

Now, the present invention will be described based on the preferred embodiments thereof with reference to the attached drawings.

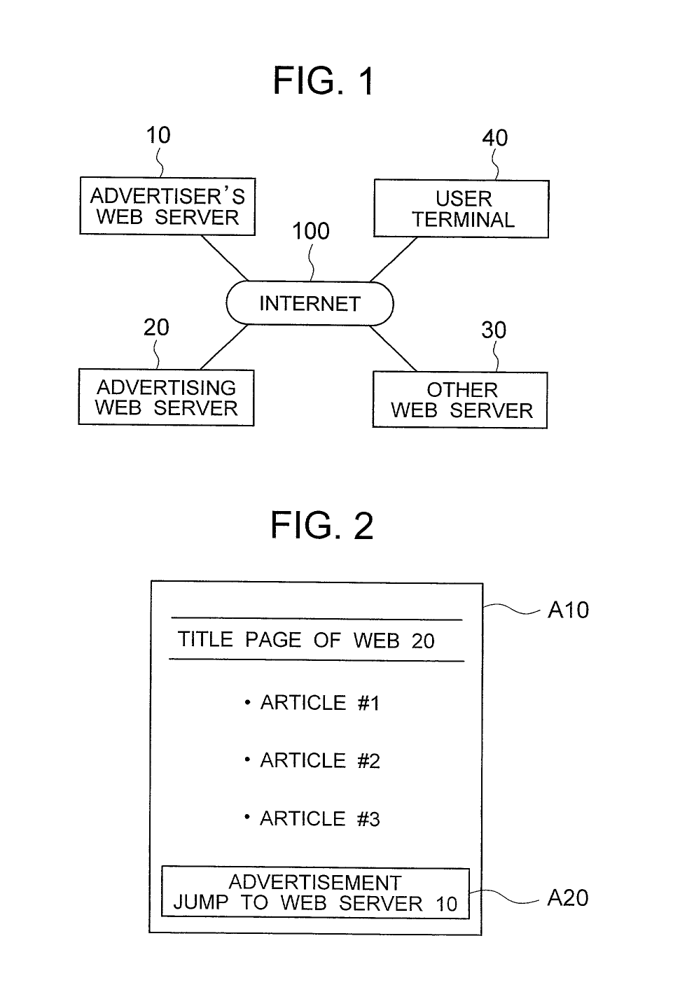

Referring to FIG. 1, an advertising system according to an embodiment of the present invention includes a plurality of user terminals 40 one of which is shown in the figure, an advertiser's web server 10, an advertising web server 20 offered by an advertising agent which provides authentic advertisement information for a plurality of advertisers, one or more of other web servers 30 each for carrying link information to the advertiser's web server without authorization of advertisements for the advertiser's web server, and Internet 100 which connects the servers 10, 20, 30 and user terminals 40 together for communication.

Each user terminal 40 is implemented by a fixed, desk top terminal or a portable data assistance having an Internet access function. The user terminal 40 has functions for accessing web servers on the Internet 100, and displaying text, image, sound, video data and the like, which are located on the web servers on its screen and described in HTML.

The advertiser's web server 10 is implemented by an information processing apparatus having an Internet access function for responding to access requests received therein, and providing information through the Internet 100 to the accessed server or terminal. The advertiser's web server 10 is owned by the advertiser who requested the advertising agent having the advertising web server 20 to display an advertisement of goods or services on the advertising web server 20.

The advertising web server 20 is implemented by an information processing apparatus having an Internet access function for responding to access requests received therein and providing information through the Internet 100. The advertising web server 20 is owned by an advertising agent and has an advertisement medium which can carry the advertisement of the advertiser's web server 10 in exchange for a certain fee. Thus, the advertising web server 20 carries advertisements for one or more of advertiser's web server in exchange for an advertising fee paid by the advertiser having the web server 10.

Each of the other web servers 30 is also implemented by an information processing apparatus having an Internet access function for responding to access requests received therein and providing information through the Internet 100. Each of the other web servers 30 is neither an advertiser's web server nor an advertising web server carrying authentic advertising medium, although it has a function for linking to the advertising web server 20 etc.

FIG. 2 shows an image displayed on a screen A10 of the user terminal when the advertising web server 20 is accessed by the user terminal 40. An advertisement A20 shown at the bottom of screen A10 is the advertisement for the advertiser's web server 10. Usually, a number of advertisements are displayed on the screen A10, and thus the advertiser's web server 10 is displayed as one of the advertised web servers. Each advertisement is composed of text or image data of an appropriate size. By clicking the image data of the web server 10 as a specified advertised web server, the user can access the advertiser's web server 10 as the selected advertised web server.

Referring back to FIG. 1, the procedure for the Internet user to access the advertiser's web server 10 by using the user terminal 40 will be described. The Internet user first accesses the advertising web server 20 where the advertisement for a plurality of web servers including the advertiser's web server 10 is carried. By clicking the image of the web server 10 in the advertising web server 20, the user can access the advertiser's web server 10.

If the user tries to directly access the advertiser's web server 10 by using the user terminal 40, the advertiser's web server 10 refuses the access request. In addition, the advertiser's web server 10 does not accept an access request from the user terminal 40 through the other web server 30 because the other web server 30 does not carry an authentic advertisement, and only has link information, as detailed below.

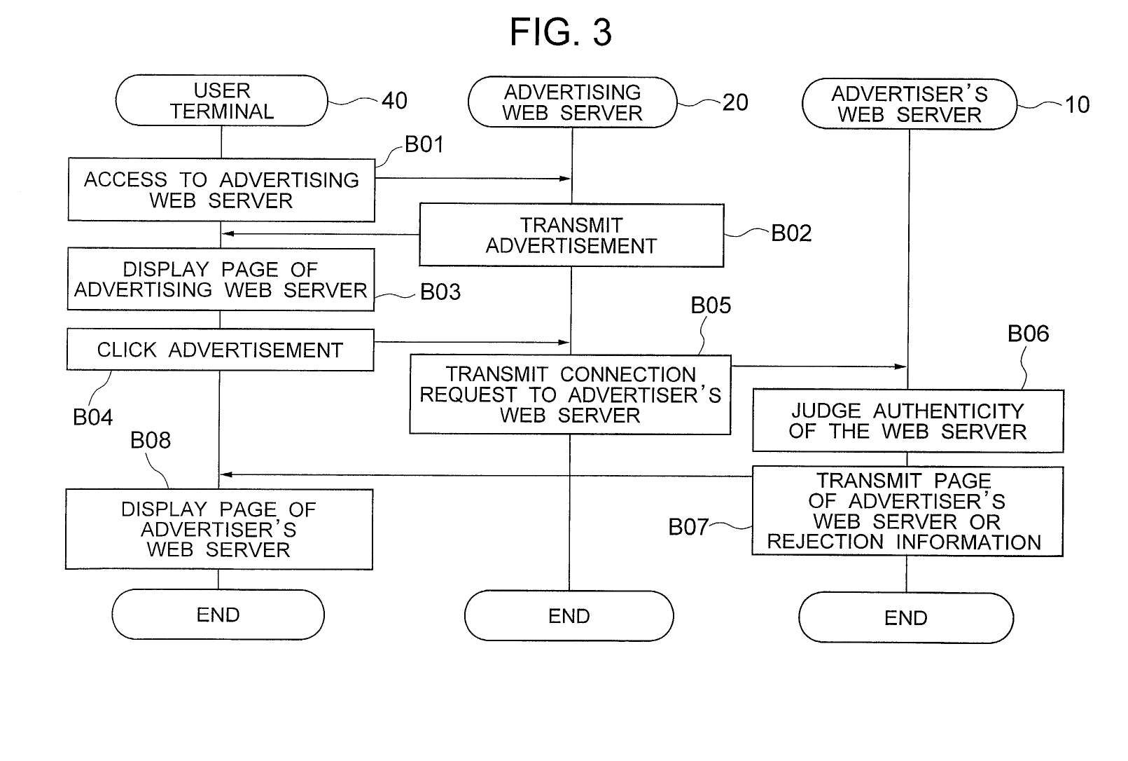

FIG. 3 shows a flowchart of the process steps in the advertising system of the present embodiment. First, the user accesses the advertising web server 20 by using the user terminal 40 (step B01). In response thereto, the advertising web server 20 transmits web page information containing advertising information to the user terminal 40 (step B02). Upon receiving the web page information from the advertising web server 20, the user terminal 40 displays an image on the screen such as shown in FIG. 2 (step B03).

If the user clicks the advertisement A20 of FIG. 2 by using a mouse pointer, the advertising web server 20 transmits a connection request to the advertiser's web server 10 (step B05). During this connection request, the advertising web server 20 transmits approval data for receiving approval of the request to access the advertiser's web server 10. This approval data includes an ID code which is unique to each advertisement or advertising web server 20. After receiving the advertisement ID code, the advertiser's web server 10 judges whether or not the web server requesting the access is one of the authentic web servers 20, by which the advertisement is provided, based on the ID code thus received. This identification is performed by comparing the received ID code against the list of advertisement ID codes stored in the advertiser's web server 10 (step B06).

Upon confirming based on the ID code that the access request is delivered from one of the authentic advertising web servers 20, the advertiser's web server 10 transmits its URL to the user terminal 40, and then transmits the data of the information page (step B07). This URL is a one-time URL which does not stay in the user terminal after the access is achieved. By receiving the page information from the advertiser's web server 10, the user terminal 40 can display the home page of the advertiser's web server 10 on its own screen (step B08).

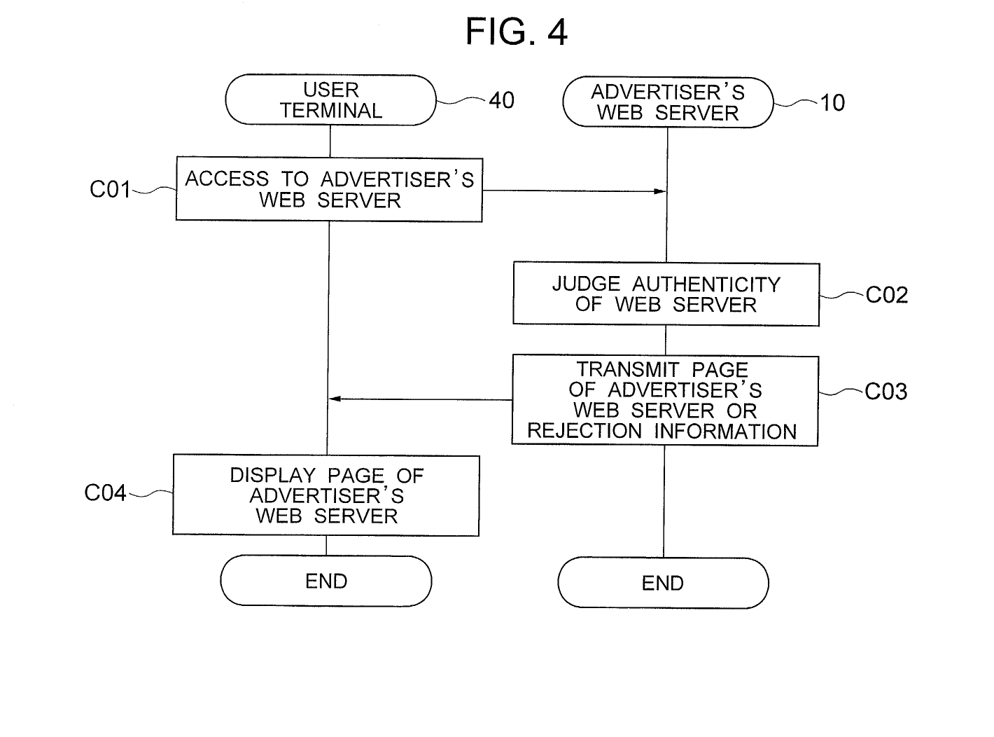

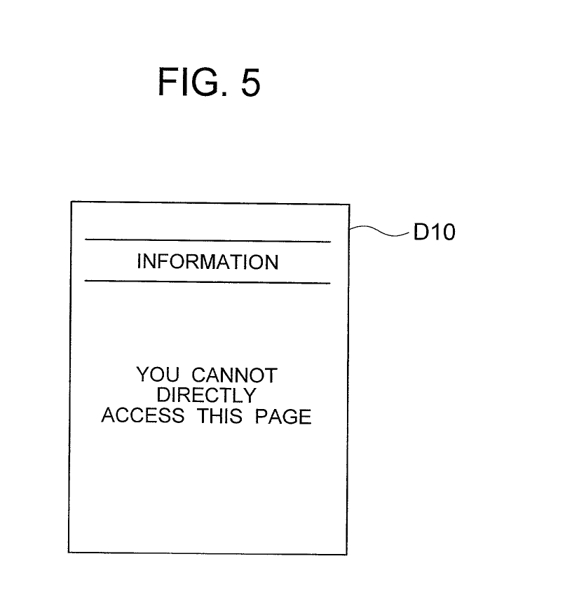

FIG. 4 shows the process steps in the case where an access request is made directly from the user terminal to the advertiser's web server 10. If the user accesses the advertiser's web server 10 through the user terminal 40 (step C01), the advertiser's web server 10 judges whether or not the access request is delivered through the advertising web server 20 having the authentic advertising medium (step C02). In this case, since the unique ID code of the advertising web server 20 is not transmitted, the advertiser's web server 10 determines that the access from the user is not transferred through the authentic advertising web server 20. Consequently, the access from the user terminal 40 is rejected. The information about the access rejection is transmitted to the user terminal 40 in step C03. Then, the user terminal 40 displays the page information received from the advertiser's web server 10, such as information D10 shown in FIG. 5 (step C04).

In the case of an access request from other web servers other than the authentic advertising medium web server 20, such as the access request from the web server 30, the ID code of the advertising medium web server 20 is not transmitted. Thus, the access request to the advertiser's web server 10 is rejected by the procedure as shown in FIG. 4.

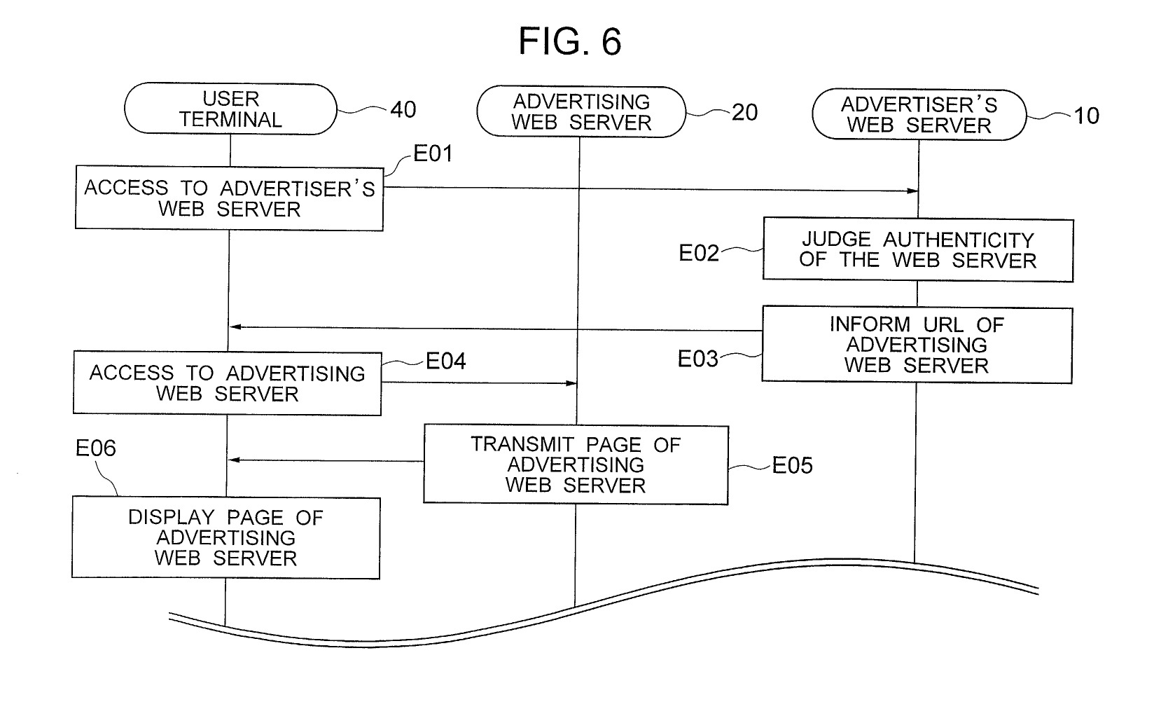

FIG. 6 shows a flowchart of the process steps in the advertising system according to another embodiment of the present invention. The system configuration is same as that shown in FIG. 1. This embodiment differs from the first embodiment in that, when the user accesses the advertiser's web server 10, the access request is not rejected and automatically guided to the advertising web server 20, as will be detailed below.

In FIG. 6, the user directly accesses the advertiser's web server 10 by using the user terminal 40 (step E01) without passing through the advertising web server 20. The advertiser's web server 10 then judges whether or not the access request from the user terminal 40 is transmitted through the authentic advertising medium (step E02). In this case, since the unique ID code of the advertising web server 20 is not transmitted, the advertiser's web server 10 determines that the access is not delivered through the authentic advertising medium. Then, the advertiser's web server 10 transmits the URL of the advertising web server 20 to the user terminal 40. If the advertiser has the advertisement placed on a plurality of advertising web servers, one of the advertising medium servers is selected based on an arbitrary algorithm, and its URL is transmitted (step E03).

The user terminal 40 then automatically accesses the URL of the advertising web server 20 received from the advertiser's web server 10 (step E04). In responses thereto, the advertising web server 20 transmits the page information carrying the advertisement of the advertiser's web server 10 to the user terminal 40 (step E05). The user terminal 40 then displays the page information received from the advertising web server 20 (step E06). The subsequent process steps are similar to those following the step B04 of FIG. 3.

Thus, the present invention provides an access limitation means whereby the Internet user cannot directly access a desired one of the advertiser's web servers unless the access is made through the advertisement of the advertising web server of the agent. The present invention thus provides a novel advertising model on the Internet which allows an increase in the number of users accessing the advertising web server, thereby facilitating the advertising business for the advertising agent.

On the other hand, the advertiser is able to make an advantageous advertising contract with the advertising agent and can reduce the advertising expenditure. Further, depending on the extent how popular the advertiser's web site is, there is a possibility that the advertiser can make an advertising income from the advertising agent, rather than vice versa, because of the increase in the number of users accessing the advertising medium of the advertising agent.

While the advertising model of the present invention is described herein based on the preferred embodiments, these embodiments are only examples and the present invention may include various changes and modifications to the specific examples disclosed above.

What is claimed is:

1. An internet advertising system comprising an advertiser's web server having service or good information, an advertising web server having advertising information of said advertiser's web server, a plurality of user terminals, and a network for connecting said advertiser's web server, said advertising web server and said user terminals together, said advertiser's web server allows an access request from each of said user terminals only if said access request passes through said advertising web server.

2. The internet advertising system as defined in claim 1, wherein said advertiser's web server induces each of said user terminals to access through said advertising web server if said advertiser's web server receives an access request directly from said each of said user terminals.

3. The internet advertising system as defined in claim 1, wherein said advertiser's web server rejects a direct access request from each of said user terminals.

4. The internet advertising system as defined in claim 1, wherein said advertiser's web server allows an access request delivered from each of said user terminals if said access request is attached with an ID code.

5. The internet advertising system as defined in claim 4, wherein said ID code is unique to said advertising web server.

6. The internet advertising system as defined in claim 1, wherein said advertiser's web server allows only an access request linked with information provided from said advertising web server to each of said user terminals.
